(19) United States
(12) Patent Application Publication
(10) Pub. No.: US 2015/0224399 A1
(43) Pub. Date: Aug. 13, 2015

(54) SYSTEMS AND METHODS FOR MANAGING GAMEPLAY HISTORY

(71) Applicant: Electronic Arts, Inc., Redwood City, CA (US)

(72) Inventor: Fernando Melo, Edmonton (CA)

(73) Assignee: Electronic Arts, Inc., Redwood City, CA (US)

(21) Appl. No.: 14/562,588

(22) Filed: Dec. 5, 2014

Related U.S. Application Data
(60) Provisional application No. 61/937,383, filed on Feb. 7, 2014.

(51) Int. Cl. A63F 13/63; A63F 13/79

(52) U.S. Cl. CPC A63F 13/63; A63F 13/79

(57) ABSTRACT

Systems and methods described herein may maintain and modify, for a player, gameplay history data associated with a set of game titles to produce modified gameplay history data. The systems and methods may validate the modified gameplay history data based on game logic data associated with the set of game titles, where the validating may comprise detecting one or more issues relating to the modified gameplay history data that cause the modified gameplay history data to be invalid based on the game logic data. The systems and methods may resolve a set of issues relating to the modified gameplay history data in response to detecting the set of issues. The systems and methods may filter the modified gameplay history data, based on filter data, to produce filtered gameplay history data, and provide the filtered gameplay history data to a client device operating an imported video game.

### CROSS-REFERENCE TO RELATED APPLICATIONS

The present application claims the benefit of U.S. Provisional Patent Application Ser. No. 61/937,383 filed Feb. 7, 2014 and entitled “World State Editor,” which is incorporated by reference herein.

### BACKGROUND

1. Technical Field

The present invention(s) generally relate to video games and, more particularly, systems and methods for managing video gameplay history.

2. Description of Related Art

Video game titles relating to a common franchise, video game storyline/plotline (hereafter, game plotline), or video game world or universe (hereafter, game world) have are popular and successful in the video gaming community. Generally, video game franchises, such as Mass Effect® or Dragon Age®, include a series of video game titles (also referred to herein as “game titles”) that are developed and released in relative succession by a video game developer. Oftentimes, game titles associated with a particular franchise offer gameplay that follows a common game plotline (e.g., one followed by gameplay in Mass Effect® titles or Dragon Age® titles), takes place within a common video game world (e.g., one in which gameplay for Mass Effect® titles or Dragon Age® titles takes place), or some combination of both. It is also traditional for a franchise game title covering a particular portion of the common game plotline to be released (e.g., concurrently released) for two or more different video game platforms (e.g., XBOX ONE®, PlayStation 4®, Nintendo WHO, PC, etc.). Game titles in the franchise are often designed so that through gameplay by a video game player (e.g., accomplishing in-game goals, obtaining in-game achievements, or making in-game choices), the video game player (hereafter, player) can progress through one or more of the game titles and impact the game plotline or game world within those game titles. For instance, gameplay involving a player making a choice with respect to an in-game task (e.g., a quest) or collecting an in-game item (e.g., a hard to find weapon) can cause a game plotline within a given game title to change (e.g., unfold the game plotline differently than it otherwise would).

Traditionally, gameplay-based changes to a game plotline or the game world are isolated to the particular game title in which the gameplay took place, and players are unable to carry those gameplay-based changes (e.g., accomplishments, gameplay choices, etc.) forward to a later-released game title that follows (e.g., succeeds) the particular game title (e.g., in progression of a common game plotline). Later-released game titles that do support importation of previous game data from previous game titles are usually limited to importing saved games of previous game titles, are usually limited to importing game data from video game titles that follow linear game plotlines, and/or sometimes result in the importation of previous game data that conflicts with current game data of the importing game title (e.g., character killed during gameplay in the previous game title is alive during gameplay in the importing game title).

### SUMMARY

Various embodiments provide for systems and methods for managing video gameplay history, which can include creating, editing, storing, importing, exporting, or utilizing gameplay history with respect to a set of game titles, such as a set of game titles associated with a video game franchise (hereafter, game franchise).

According to some embodiments, systems and methods (e.g., at a server) obtain, with respect to a player, gameplay history data associated with a set of game titles that includes a first game title. The gameplay history data may be one maintained at a gameplay history repository (e.g., an online repository). For example, the gameplay history repository may receive the gameplay history data from client devices as players play or replay the first game title, or may generate the gameplay history data at the request of a player without need for the player to play or replay the game. The gameplay history data may be validated before being maintained (e.g., stored) by the gameplay history repository. The systems and methods may (e.g., according to a player instruction or request) modify gameplay history data associated with the first game title to produce first modified gameplay history data, where the gameplay history data is associated with the player and is also associated with the set of game titles including the first game title. The systems and methods may validate the first modified gameplay history data based on video game logic data (hereafter, game logic data) associated with the set of game titles. Validating the first modified gameplay history data based on game logic data may comprise determining whether the first modified gameplay history data raises one or more issues that cause the first modified gameplay history data to be invalid. The one or more issues raised by the first modified gameplay history data may be the result of modifications applied to the gameplay history data to produce the first modified gameplay history data. The systems and methods may resolve a first set of issues raised by the first modified gameplay history data to produce modified and resolved gameplay history data. The systems and methods may filter the modified and resolved gameplay history data, based on filter data, to produce filtered gameplay history data, the filter data being associated with a second game title. The systems and methods may provide (e.g., export) the filtered gameplay history data to the second game title (or other software, which may be operating on a client device that is remote with respect to the systems and methods.

For some embodiments, the filter data comprises a filter or filter rule that identifies a subset of data in the gameplay history data that will be included in the filtered gameplay history data to be produced. The subset of data identified by the filter or filter rule may be one that is relevant to or compatible with the target game title intending to import the filtered gameplay history data. For instance, a given filter or filter rule may only identify a subset of data, in the gameplay history data, that is known to influence or alter the game plotline of the target game title that is intending to imported the filtered gameplay history data. Additionally, the filter data may determine the format or sequence in which data in the filtered gameplay history data is organized.

Depending on the embodiment, the gameplay history data may comprise a set of gameplay flags that determines at least a portion of a state of a game world associated with the first game title, and the state of the game world determines at least a portion of a gameplay environment provided by the first game title or a game plotline followed by the first game title. The gameplay history data may be an existing copy of gameplay history data associated with the player, or a new copy of gameplay history data generated based on a default gameplay history data (e.g., template gameplay data associated with a given game title).

In some embodiments, the modifying the gameplay history data based on the request by the player comprises modifying a gameplay flag included in the gameplay history data. The gameplay flag may represent a gameplay choice available for selection by the player during gameplay of the first game title, or a player accomplishment earned during gameplay of the first game title.

In some embodiments, the resolving the first set of issues relating to the first modified gameplay history data comprises determining a minimal set of modifications to the first modified gameplay history data that resolve at least some of the first set of issues, and applying the minimal set of modifications to the first modified gameplay history data. The minimal set of modifications may include at least one modification relating to a gameplay choice locked by the player, which may result in the player being prompted to act (e.g., remove the lock on the gameplay choice, thereby allowing the resolution to continue). Applying the minimal set of modifications to the first modified gameplay history data produces second modified gameplay history data. The systems and methods may validate this second modified gameplay history data based on logic data that is associated with the first game title, where the validating comprises determining whether the second modified gameplay history data raises one or more issues that cause the second modified gameplay history data to be invalid. The systems and method may also resolve a second set of issues raised by the second modified gameplay history data to produce interim gameplay history data, and may replace the first modified gameplay history data with the interim gameplay history data. For some embodiments, the cycle of validating the first modified gameplay history data, and resolving the first set of issues raised by the first modified, are repeated until the first modified gameplay history data is determined to be valid

Various embodiments provide for a computer program product comprising computer instruction codes configured to cause the computer system to perform various operations described herein.

Other features and aspects of various embodiments will become apparent from the following detailed description, taken in conjunction with the accompanying drawings, which illustrate, by way of example, the features of such embodiments.

### BRIEF DESCRIPTION OF THE DRAWINGS

Various embodiments are described in detail with reference to the following figures. The drawings are provided for purposes of illustration only and merely depict some embodiments. These drawings shall not be considered limiting of the breadth, scope, or applicability of embodiments.

FIG. 1 is a block diagram illustrating an example environment utilizing a gameplay history system in accordance with various embodiments.

FIG. 2 is a block diagram of an example gameplay history client module in accordance with some embodiments of the invention.

FIG. 3 is a block diagram of an example gameplay history system in accordance with some embodiments of the invention.

FIG. 4 is a diagram illustrating an example data flow of a gameplay history system in accordance with some embodiments of the invention.

FIG. 5 is a flowchart illustrating an example method for gameplay history in accordance with some embodiments of the invention.

FIG. 6 is a block diagram of an exemplary digital device.

### DETAILED DESCRIPTION OF EMBODIMENTS

Various embodiments provide for systems and methods for managing gameplay history, which can include creating, editing, storing, importing, exporting, or utilizing gameplay history with respect to a set of game titles, such as a set of game titles associated with a game franchise.

According to some embodiments, systems and methods (e.g., at a server) may facilitate maintaining gameplay history data at a gameplay history data repository (e.g., online repository), where the data may be maintained in association with a set of game titles and may be maintained separate for individual players (e.g., player one and player two have separate gameplay history data maintained by the gameplay history data repository). Additionally, for a given player, the gameplay history data repository may maintain separate sets (e.g., versions) of gameplay history data for a given set of game titles. The gameplay history data maintained by the gameplay history data repository may be received from a client device as (or after) a player plays one or more game titles (at the client device) that are associated with the gameplay history data. For example, as a player at a client device plays Mass Effect® and Mass Effect® 2, the client device will provide the gameplay history data repository with gameplay history data relating to those game titles, and the gameplay history data repository may store the data or update any data the gameplay history data repository is already maintaining in connection with those game titles. The gameplay history data maintained by the gameplay history data repository may also be generated at the gameplay history data repository in connection with a set of game titles without need for a player to actually play or replay those game titles.

Gameplay history data associated with a first set of game titles (e.g., Mass Effect® and Mass Effect® 2) and maintained by a gameplay history data repository can later be imported into a second set of game titles (e.g., Mass Effect® 3 or Mass Effect® Galaxy), which may be related to the first set of game titles (e.g., Mass Effect® game franchise). Once imported in one game title in the second set of game titles, the gameplay information provided by imported gameplay data can alter or influence the gameplay provided by the importing game title.

As used herein, gameplay will be understood to include one or more player interactions with respect to a game title, which may be facilitated through a game controller or other form of human interface device (e.g., mouse, keyboard, etc.). Example player interactions can include a player performing an action, making a choice, collecting an in-game item, or the like within a game environment provided by a game title.

As used herein, video gameplay history (hereafter, gameplay history), will be understood to include one or more choices or actions taken (or that could have been taken) by a player during gameplay of one or more game titles in a set of game titles. Once imported into a game title, gameplay history data can alter or otherwise affect at least a portion of a game plotline or a game world involved in the gameplay provided by the game title importing the gameplay history data. As used herein, different game titles can include different iterations of a video game franchise that provide gameplay covering different portions of a common game plotline (e.g., Mass Effect® 1, 2 and 3), game expansion packs, game spinoffs (e.g., Mass Effect® Galaxy), which may provide gameplay covering different game plotlines in a common game world, and game titles that provide gameplay covering a similar or identical portions of a game plotline but released for different video game platforms (e.g., Mass Effect 3 for XBOX 360® is a separate game title from Mass Effect 3 for PlayStation 3®, Nintendo Wii U®, or the PC).

For various embodiments, a player is provided with a view (e.g., summary) of one or more choices or actions (e.g., accepting a quest, completing a task, collecting an item, killing a character, etc.) that are usually available to players during gameplay in a set of game titles, but that are now available for the player to select or modify (through systems or methods of the various embodiments) without need for the player to actually play or replay the game titles in the set. Hereafter, gameplay choices will be understood to refer to gameplay choices that can be selected by a player or gameplay actions that can be taken by a player. In some embodiments, the gameplay choice corresponds to, causes, or represents a key event in a game plotline that can impact the future availability of other gameplay choices. The key event may be one for a linear or a non-linear game plotline. By allowing a player to select or modify one or more gameplay choices in a gameplay history associated with a set of game titles, some embodiments can define, generate, or otherwise produce gameplay history data that includes data relating to those selected/modified gameplay choices, and that can be imported into game titles having gameplay that logically follow the release of the set of game titles (e.g., later-released franchise game titles that continue a game plotline from one or more previous game titles, or having gameplay associated with a game world common to previous game titles). The importation of such gameplay history into a later-released game title can affect the later-released game title's game plotline or game world, which in turn can affect the game environment presented by the later-released game title during a player's gameplay. For some embodiments, the set of game titles and the later-released game titles are associated with a particular game franchise, such as Mass Effect®, Dragon Age®, or the like. It will be understood that for some embodiments, game titles that are associated with a particular franchise and support gameplay history importation as described herein may follow a common game plotline or contain a common game world, but may or may not differ in game type (e.g., first franchise game title is a first-person-shooter [FPS], second franchise game title is a role playing game [RPG], third franchise game title is a massively multiplayer online game [MMOG], etc.).

For some embodiments, an automatic solver/resolver (hereafter, automatic solver) can detect for and resolve conflicts caused in the gameplay history by a player selecting or modifying a particular gameplay choice in the gameplay history. In this way, some such embodiments can ensure that gameplay history produced after a player's selection or modification is valid based on game logic that governs the gameplay provided by one or more game titles that may import and subsequently utilize the gameplay history (e.g., utilized by those game titles in defining or modifying the gameplay they provide). Through validation, some embodiments ensure that gameplay information provided by gameplay history data for a set of game titles is consistent with game logic governing gameplay in one or more game titles that may import and utilize the gameplay history data (e.g., franchise game titles that logically follow the set of game titles with respect to a common game plotline).

For instance, where gameplay history data relating to a set of earlier-released game titles indicates that during gameplay in those earlier-released game titles, a player made particular gameplay selections (or took certain gameplay actions) that resulted in the death of a specific game character, the validation process could detect when this gameplay choice in the gameplay history data conflicts with the game logic associated with (e.g., governing) a later-released game title (e.g., game logic indicates that the specific game character is still alive in the game plotline). In such a situation, the automatic solver may automatically adjust one or more of the gameplay choices in the gameplay history data such that they are consistent with the game logic of the later-released game title, or may prompt a player for action when the one or more gameplay choices are unable to be adjusted to resolve the conflict (e.g., the player locked one or more of the gameplay choices). For some embodiments, the automatic solver attempts to resolve conflicts with the least amount of modifications to the gameplay choices in the gameplay history data, or attempts to resolve conflicts in a manner that causes the least amount of impact on the overall gameplay history. Additionally, when the automatic solver resolves a conflict by modifying a given gameplay choice in the gameplay history data, the modification may result in the automatic solver performing a cascade of modifications to one or more other gameplay choices in the gameplay history data to ensure the gameplay history data is valid (e.g., consistent) with respect to the game logic governing the gameplay of the same or later-released game titles. The cascade of modifications may be affected according to the game logic and, more particularly, a logic tree (e.g., decision tree) that describes how selection of gameplay choices influences (e.g., the availability or possibility of) subsequent gameplay choices. The logic tree may, for instance, describe a complex, non-linear branching choices for gameplay choices available for player selection during gameplay.

Depending on the embodiment, a player can generate gameplay history data relating to a set of game titles, without having to play or replay those game titles, and import the generated gameplay history in another game title (e.g., game title that succeeds the game titles). In this way, a player wishing to play or replay a later-released game title for a game franchise can, for example, modify the gameplay of the later-released game title, using gameplay history data relating to gameplay choices presented during one or more earlier-released game titles in the game franchise, without the need for playing or replaying the earlier-released game titles. As described herein, a player can select or modify gameplay choices described in the gameplay history data before the gameplay history data is imported by the same game title or another game title. Once gameplay history data is generated or exported by a particular game title, that particular game title may import that gameplay history data back where, for example, a player desires to modify a gameplay choice he or she previously made during gameplay of the particular game title but which the player does not wish to change by replaying the particular game title from that gameplay choice onward. This may be particularly useful where, for instance, the gameplay choice the player desires to modify represents a key event in the game plotline of the particular game title that has a significant impact on how the game plotline unfolds, or the player has progressed significantly along the game plotline from where the gameplay choice was made.

Depending on the embodiment, a player can instruct a game title to generate (e.g., to export) gameplay history data from the game title that describes one or more gameplay choices made by the player during actual gameplay of the game title, and the generated gameplay data can be imported by another game title, such as one that succeeds game title generating the gameplay history data. The other game title may also be one that covers an identical game plotline to the game title generating (e.g., exporting) the gameplay history data, but that is released for another video game platform, thereby permitting a player to easily transfer gameplay efforts on one video gaming platform to another video gaming platform. For instance, one or more gameplay choices performed with respect to a copy of Mass Effect® 3 operating on the XBOX ONE®, representing a first game title, may be exported as gameplay history data (e.g., possibly to an online repository for gameplay history data). Subsequently, a copy of Mass Effect® 3 on PlayStation 4®, which represents a second game title, imports some or all of previously exported gameplay history data (e.g., from the online repository for gameplay history data).

Depending on the embodiment, a game title may automatically export gameplay history data to an online repository for gameplay history data based on a player's gameplay of the game title, and the game title may further update the gameplay history data on the online repository at or near real-time during the player's gameplay.

For some embodiments, when gameplay history data is generated, exported, imported, or modified, it is done so in association with a particular player. For instance, a player may generate or export gameplay history data in association with their online gamer id, or in association with an account identifier used in conjunction with an online repository for gameplay history data. Depending on the embodiment, once gameplay history data is exported or generated by a player to an online repository for gameplay history data, the exported/generated gameplay history can be managed in association with the player, and may be modified (e.g., edited) through the online repository according to player instructions. For instance, a player may export a first gameplay history data to the online repository, generate a copy of the first gameplay history data, and modify the copy of the first gameplay history data to produce second gameplay history data. Subsequently, the player may import the first or second gameplay data from the online repository into a game title. As the player generates, exports, imports, or modifies the gameplay history data (e.g., modify gameplay choice in the gameplay history data), the resulting gameplay history data may be validated/revalidated and, if necessary, auto-solved to ensure that the resulting gameplay history data is valid with related game logic.

In some embodiments, a player can share their associated gameplay history data with one or more other players, which may or may not include conditions or restrictions to the share. A first player, for instance, may share their associated gameplay history data with a second player that permits the second player to review the shared gameplay history data (e.g., review a visual summary representing key events according to the gameplay history data), obtain a copy the shared gameplay history data associated with the second player, modify the gameplay history data, and/or import the gameplay history data into a game title being played by the second player.

Though various embodiments are described herein with respect to video games and video game-related products, those skilled in the art will appreciate that systems and methods described herein can be implemented with respect to a variety of products involving user interaction (i.e., interactive products), such as other interactive non-game experiences supporting user-interactive capabilities.

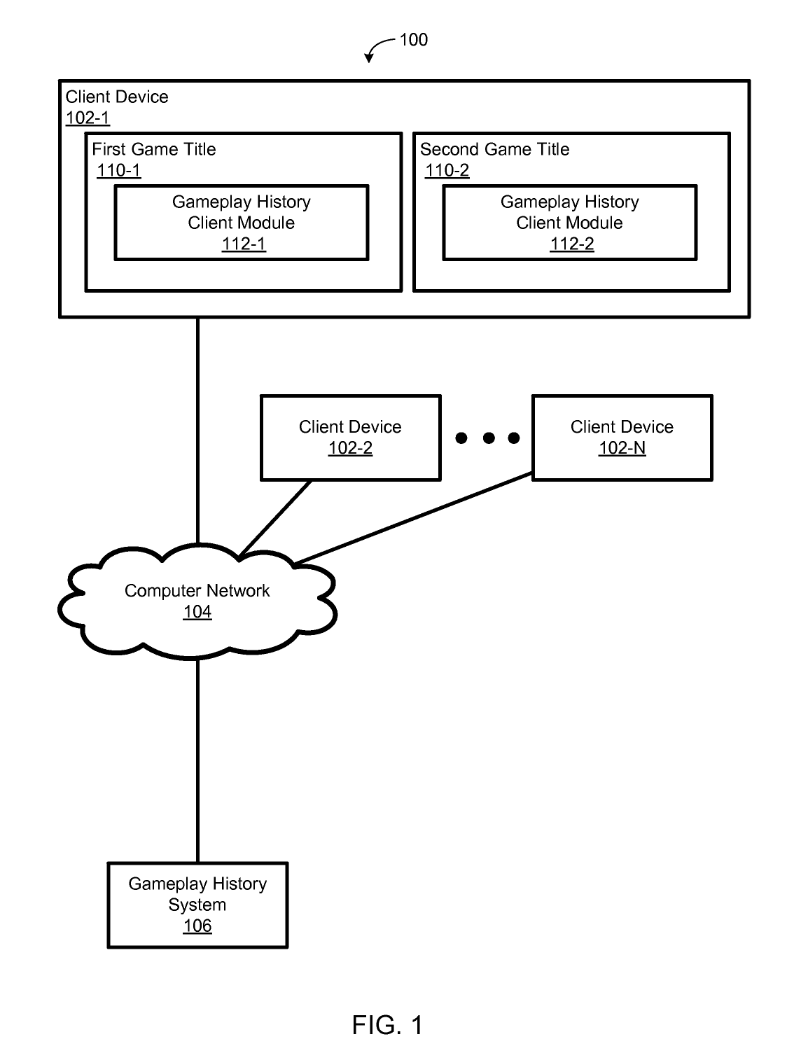

FIG. 1 is a block diagram illustrating an example environment 100 utilizing a gameplay history system in accordance with various embodiments. As shown in FIG. 1, the example environment 100 can include client devices 102-1 through 102-N (hereafter, collectively referred to as client devices 102), a gameplay history system 106, and a computer network 104 communicatively coupling together each of the client devices 102 and the gameplay history system 106. It will be understood that for some embodiments, the components or the arrangement of components may differ from what is depicted in FIG. 1. In accordance with some embodiments, the computer network 104 may be implemented or facilitated using one or more local or wide-area communications networks, such as the Internet, WiFi networks, WiMax networks, private networks, public networks, game-service specific networks (i.e., those owned by game platform holders), and the like.

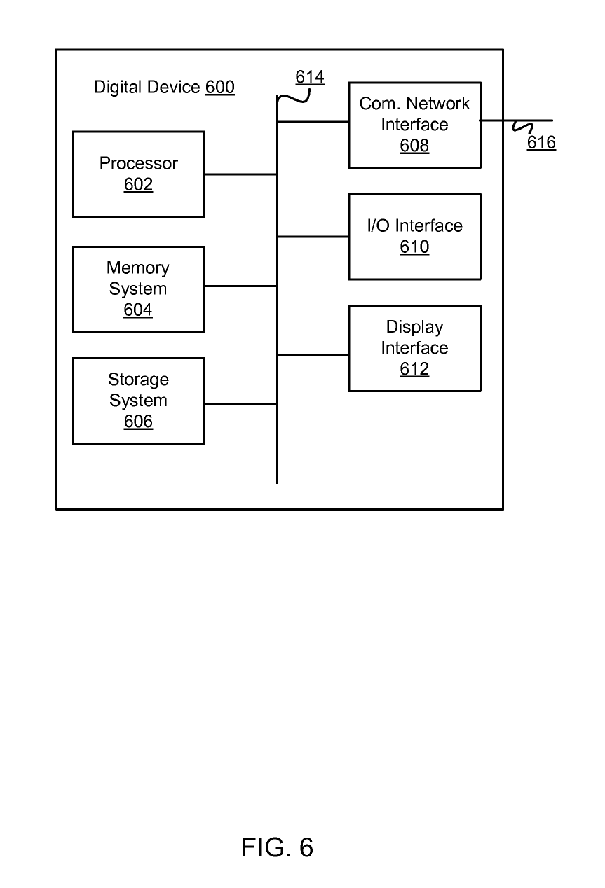

Each of the client devices 102, and the gameplay history system 106 may be implemented using one or more digital devices, which may be similar to the digital devices discussed later with respect to FIG. 6. For example, one or more of the client devices 102 may be any form of computing device, such as a video game console, tablet, phone, personal computer (PC), etc., capable of enabling a user to play, view, share, etc. a game title, presenting a video game user interface through a display coupled to the computing device, receiving user input from a player (e.g., entered through a game controller coupled to the computing device), and communicating with various entities in the example environment 100 through the computer network 104.

For instance, through the computer network 104, the client device 102-1 can provide to the gameplay history system 106 (e.g., export) gameplay history data, or updates to gameplay history data, as a player is playing or replays a first game title 110-1 on the client device 102-1. The gameplay history data, or updates to gameplay history data, provided to the gameplay history system 106 by the client device 102-1 may be in association with the player that is participating in the gameplay of the first game title 110-1, so that the gameplay history system 106 can maintain (e.g., store) the data/update on behalf of the player. As another example, through the computer network 104, the client device 102-1 can receive gameplay history data from the gameplay history system 106 and import some or all of the gameplay information provided by the receive gameplay history data into the first game title 110-1 on the client device 102-1, thereby influencing or otherwise altering the gameplay provided by the first game title 110-1. The gameplay history data may be associated with the first game title, and may only contain gameplay information relevant or compatible with the first game title 110-1. Additionally, when the first game title 110-1 imports the gameplay history data, it may do so such that the imported gameplay history data only affects the gameplay history data of those players of the first game title 110-1 who requested the importation of the gameplay history data, or those players for whom the gameplay history system 106 associates with the gameplay history data (e.g., those players for whom the gameplay history system 106 is maintaining the gameplay history data).

One or more of the client devices 102 may include a video game console, a portable gaming console, a mobile phone, a tablet computing device, a laptop, a desktop computer, personal digital assistant, a thin client, a set-top box, a portable multi-media player, or any other type of network accessible user device known to those of skill in the art. Further, the gameplay history system 106 may comprise of one or more servers, which may be operating on or implemented using one or more cloud-based resources (e.g., System-as-a-Service [SaaS], Platform-as-a-Service [PaaS], or Infrastructure-as-a-Service [IaaS]).

According to some embodiments, one or more of the client devices 102 is communicatively coupled to the gameplay history system 106, and may do so by way of the online video game network. Through such a coupling, the one or more of the client devices 102 can provide, and the gameplay history system 106 can receive and maintain data regarding gameplay history of one or more players participating in gameplay provided by various game titles operating on those client devices 102. Additionally, through such a coupling, the gameplay history system 106 can provide one or more client devices 102 with gameplay history data for a particular game title or in association with a particular player. Further, through such a coupling, a particular player at one of the client devices 102 can facilitate generation or modification of gameplay history data at the gameplay history system 106, where the gameplay history data may be generated or modified in association with one or more game titles (e.g., a set of related game titles from the same franchise) and may be generated or modified in association with the particular player.

As described herein, for a particular player, the gameplay history system 106 can generate gameplay history data associated with a set of game titles without need for the particular player to actually play, replay, or have access to the set of game titles to which the gameplay history data relates. As also described herein, once the gameplay history system 106 is maintaining gameplay history data in association with a particular player, the particular player can access the gameplay history system 106 (e.g., from one of the client devices 102) to review or modify the gameplay information contained in the gameplay history data. In the event of that the gameplay history system 106 receives gameplay history data or receives a modification or update to the gameplay history data it already maintains, the gameplay history system 106 may validate or revalidate the gameplay history data based on game logic data that is associated with the set of game titles to which the gameplay history data relates.

As shown in FIG. 1, the client device 102-1 comprises the first game title 110-1 and a second game title 110-2, each respectively including gameplay history client modules 112-1 and 112-2. For some embodiments, each of the gameplay history client modules 112-1 and 112-2 allow their respective game titles to access features or capabilities provided by the gameplay history system 106. For instance, the gameplay history client module 112-1 may enable the first game title 110-1 to send or otherwise provide gameplay history data, which may include gameplay choices, to the gameplay history system 106. Depending on the embodiment, a set of game titles may individually include a gameplay history client module, as shown in FIG. 1, or the client device may include a gameplay history client module that is shared by the set of game titles. For instance, either the gameplay history client module 112-1 may be a component of the client device 102-1 that is external (e.g., separate software program) to the first game title 110-1 and the second game title 110-2, and both the first game title 110-1 and the second game title 110-2 may access the gameplay history client module 112-1 to access features or capabilities provided by the gameplay history system 106.

The gameplay history data sent or provided by the first game title 110-1 or the second game title 110-2 to the gameplay history system 106, via their respective gameplay client module, may be utilized (e.g., imported) by one or more other game titles (e.g., future game titles or later released game titles), which may continue a common game plotline or contain a common game world of the first game title 110-1 or the second game title 110-2. In another example, the gameplay history client module 112-1 may enable the first game title 110-1 to receive gameplay history data from the gameplay history system 106, and import the gameplay history data into game plotline or game world of the first game title 110-1, thereby influencing or altering the gameplay provided by the first game title 110-1 to a player at the client device 102-1. As described herein, the gameplay information contained in the gameplay history data imported by the first game title 110-1 may reflect a player's gameplay choices made during gameplay of a set of game titles that may have preceded the first game title 110-1 on a common game plotline.

The gameplay history system 106 may be configured to receive gameplay history data from client devices 102 or generate gameplay history data on behalf of a player, and then maintain the received/generated gameplay history data on a datastore (e.g., for future importation or modification). For some embodiments, before gameplay history data associated with a set of game titles is stored on the gameplay history system 106 and available for use, the gameplay history system 106 validates the gameplay history data using game logic data associated with the set of game titles. The validation process may occur for gameplay history data received from one of the client devices 102, after generation of gameplay history data at the gameplay history system 106, or after gameplay history data being maintained at the gameplay history system 106 is modified by a player. The game logic data utilized for validation may describe a logic tree that defines or governs gameplay provided by the set of game titles, and which may further describe how selection of certain gameplay choices influence (e.g., the availability or possibility of) subsequent gameplay choices. Based on issues detected during the validation process, the gameplay history system 106 may automatically adjust one or more gameplay choices in the gameplay history data to solve/resolve the detected issues. For example, for a player modified gameplay choice, the gameplay history system 106 may adjust gameplay choices that precede or follow the player modified gameplay choice to resolve any gameplay conflicts detected during the validation process.

For some embodiments, the gameplay history system 106 allows a player to access gameplay history data maintained by the gameplay history system 106, where access includes reviewing or modifying the gameplay history data based on player instructions. Depending on the embodiment, the player may access the gameplay history data using a gameplay history editor interface, which may be provided by the gameplay history system 106 as a web site accessible from a web browser on a client device, or which may be provided by the gameplay history system 106 through one of the gameplay history client modules 112-1 or 112-2. For some embodiments, the gameplay history system 106 provides a player with an interactive or visual view of the gameplay history data maintained by the gameplay history system 106. Depending on the embodiment, the interactive or visual view may present the player with the current state of a game plotline or a game world in view of (e.g., as influenced or altered by) the gameplay history data maintained by the gameplay history system 106. For example, the view may provide the user with a visual summary of key events in the game plotline or game world in view of the gameplay history data, and may further permit the user to interact with the visual summary to modify those key events (e.g., the outcome of key events) in the game plotline or the game world. The gameplay history system 106 may implement the modification to a key event by performing a set of modifications to one or more gameplay choices in the gameplay history data that can result in the modified key event occurring in the game plotline or game world. Once validated, the modified gameplay history data may be maintained by the gameplay history system 106 for future use (e.g., further modification or importation).

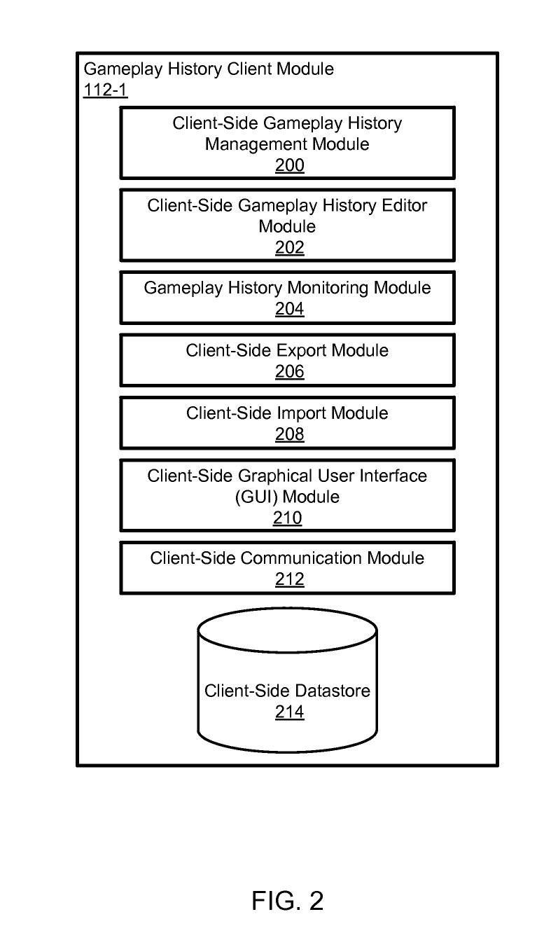

FIG. 2 is a block diagram of the gameplay history client module 112-1 in accordance with some embodiments of the invention. As shown in FIG. 2, the gameplay history client module 112-1 can comprise a client-side gameplay history management module 200, a client-side gameplay history editor module 202, a gameplay history monitoring module 204, a client-side export module 206, a client-side import module 208, a client-side graphical user interface (GUI) module 210, a client-side communication module 212, and a client side datastore 214. Those skilled in the art will appreciate that components of the gameplay history client module 112-1, and functionality of those components, may differ between various embodiments.

The client-side gameplay history management module 200 may be configured to facilitate management of gameplay history data residing on a client device (e.g., the client-side datastore) or gameplay history data being maintained on a gameplay history system (e.g., the gameplay history system 106), which may be physically remote from the client device including the client-side gameplay history management module 200. For instance, the client-side gameplay history management module 200 may enable a player at a client device to review, copy, remove, or otherwise manage gameplay history data residing on a client device or being maintained by a gameplay history system. The client-side gameplay history management module 200 may also allow a player to share the gameplay history data maintained by a gameplay history system with one or more other players, who may also have access to the gameplay history system maintaining the gameplay history data. When sharing their gameplay history data with other players, a player can define access privileges to the gameplay history data being shared, thereby limiting access by other players to read-only access, read and copy access, read/write access, or the like. For example, a first player may share with a second player their gameplay history data, under copy-allowed access. The second player, in turn, may create a copy of the shared gameplay history data and import the copied gameplay history data from the gameplay history system to one of their game titles that will use the imported gameplay data.

The client-side gameplay history editor module 202 may facilitate the creation or modification of gameplay history data being maintained on a gameplay history system (e.g., the gameplay history system 106). Through the client-side gameplay history editor module 202, a player may review their gameplay history data according to game titles, may review a game plotline or how this game world is influenced by gameplay choices described in the gameplay history data, and may select and modify one or more gameplay choices in the gameplay history data to affect a change in the game plotline or game world. As described herein, when a player is reviewing a game plotline or a game world as influenced by gameplay history data, the player may be presented with a visual and interactive view of the game plotline or the game world, through which the player can select and modify a key event, causing one or more modifications to gameplay choices in the gameplay history data.

The gameplay history monitoring module 204 may be configured to monitor player gameplay of a game title at a client device, and facilitate collection of information regarding the player gameplay of the game title The client-side export module 206 may be configured to generate gameplay history data based on the collected gameplay information, and provide the resulting gameplay history data for export to a gameplay history system (e.g., the gameplay history system 106) via the client-side communication module 212. For some embodiments, gameplay information collected by the gameplay history monitoring module 204 may be determined by settings or parameters associated with the gameplay history monitoring module 204, which may be received from the gameplay history system (e.g., the gameplay history system 106). Gameplay information collected, or the types of gameplay information collected, by the gameplay history monitoring module 204 may vary between different game titles. In some embodiments, collection of gameplay information by the gameplay history monitoring module 204 may be facilitated by a game title providing the gameplay information to the gameplay history monitoring module 204. A game title developer may determine which pieces of gameplay information are collected from each game title by the gameplay history monitoring module 204, or may determine which pieces of gameplay information are provided by a game title to the gameplay history monitoring module 204 for collection. The gameplay information collected from various game titles by the gameplay history monitoring module 204 may have a standard format recognized by the gameplay history monitoring module 204.

The client-side import module 208 may be configured to facilitate the importation of gameplay history data, received from a gameplay history system (e.g., the gameplay history system 106), into one or more game titles operating at a client device (e.g., the first game title 110-1 included by the client device 102-1). Depending on the embodiment, the gameplay history data imported into a target game title by the client-side import module 208 may be first obtained by the client-side gameplay history management module 200. Additionally, the gameplay history data imported into a target game title by the client-side import module 208 may describe gameplay information for one or more game titles that are related (e.g., same game franchise), and that probably preceded the release of, the target game title. When importing gameplay history data into a target game title, the client-side import module 208 may import the gameplay information into (e.g., apply the gameplay information to) an existing saved game session for target game title or a newly created game session for the target game title.

The client-side GUI module 210 may be configured to facilitate generation or presentation of a graphical user interface at a client device (e.g., the client device 102-1) that permits a player at the client device to access or interact with various features provided through the gameplay history client module 112-1. For instance, the client-side GUI module 210 may facilitate the generation or presentation of a visual and interactive view that summarizes key events of a game plotline in view of gameplay history data being maintained by a gameplay history system (e.g., the gameplay history system 106).

The client-side communication module 212 may be configured to facilitate communication of data between the gameplay history client module 112-1 and a game strategy system, such as the gameplay history system 106. In some embodiments, the client-side communication module 212 may directly communicate data with the game strategy system, may communicate data by way of an online video game network, or may communicate data by some combination both. In doing so, the client-side communication module 212 may utilize one or more network connections with the game strategy system or the online video game network to communicate the data.

The client side datastore 214 may be configured to facilitate storage and future retrieval of gameplay history data received from a gameplay history system (e.g., the gameplay history system 106) for review or importation purposes. The client side datastore 214 may also be configured to facilitate storage and future retrieval of gameplay history data that is generated by game titles operating on a client device that include the gameplay history client module 112-1. The client-side game strategy datastore 212 may include data regarding settings, game player preferences, or other information that can affect the behavior or operation of the gameplay history client module 112-1 or its various components.

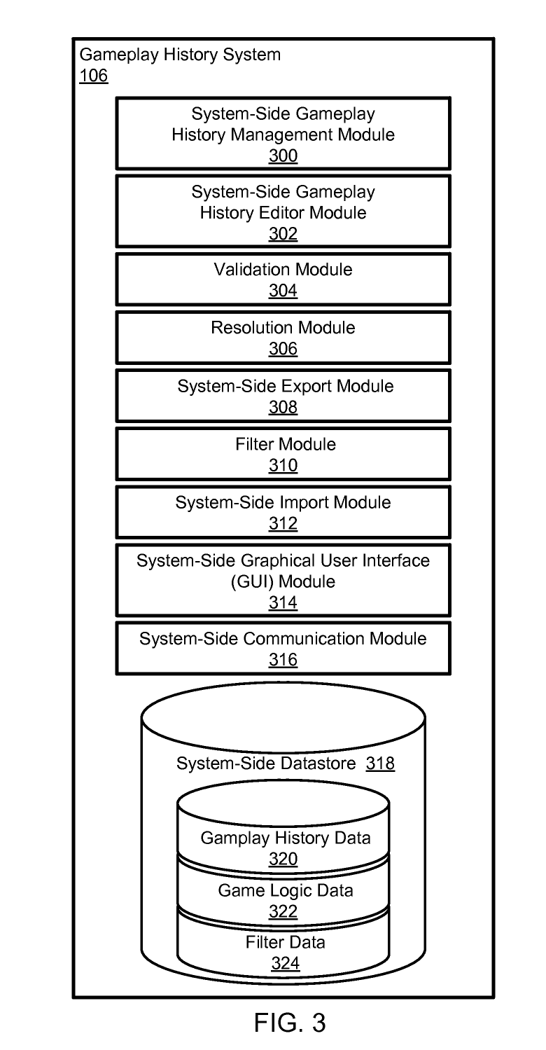

FIG. 3 is a block diagram of the gameplay history system 106 in accordance with some embodiments of the invention. As shown in FIG. 3, the gameplay history system 106 can comprise a system-side gameplay history management module 300, a system-side gameplay history editor module 302, a validation module 304, a resolution module 306, a system-side export module 308, a filter module 310, a system-side import module 312, a system-side graphical user interface (GUI) module 314, a system-side communication module 316, and a system-side datastore 318, which can include gameplay history data 320, game logic data 322, and filter data 324. Those skilled in the art will appreciate that components of the gameplay history system 106, and functionality of those components, may differ between various embodiments.

The system-side gameplay history management module 300 may be configured to facilitate management of gameplay history data being maintained on the gameplay history system 106 (e.g., on the system-side datastore 318), which may be remote from a client device operating game title. For instance, the system-side gameplay history management module 300 may enable a player at a client device to review, copy, remove, or otherwise manage gameplay history data being maintained by the gameplay history system 106. The system-side gameplay history management module 300 may also permit a player to share the gameplay history data maintained by the gameplay history system 106 with one or more other players who are members of the gameplay history system 106. As described herein, a player may share their gameplay history data with one or more other players and may impose access privileges on the gameplay history data being shared (e.g., read-only access, read and copy access, or read and write access). As also described herein, the system-side gameplay history management module 300 may enable a player to maintain different versions of gameplay history data for the same set of game titles, and may further enable the player to modify each of those versions differently to experience different game plotlines or different game worlds for a given game title.

For instance, a player may instruct the system-side gameplay history management module 300 to generate and then maintain multiple versions of gameplay history data covering gameplay for Mass Effect® and Mass Effect® 2, with each version being modified to alter the game plotline of Mass Effect® 3 differently, which in turn may cause the game plotline to unfold differently. For example, the player may choose to import a first version of the gameplay history data into a copy of Mass Effect® 3 (e.g., operating on a game console, such as XBOX 360®) and import a (different) second version of the gameplay history data into the same copy of Mass Effect® 3. When the player wishes to experience one version of Mass Effect® 3's plotline, the player may load the first version of the gameplay history data, imported into the copy of Mass Effect® 3, into the system. When the player wishes to experience another version of Mass Effect® 3's plotline, the player may load the second version of the gameplay history data, imported into the copy of Mass Effect® 3, into the system. Once a player has imported gameplay history data into a game title and set the imported gameplay history data as active, the player's subsequent gameplay may result in updated gameplay data to be generated and provided by a gameplay history client module (e.g., the gameplay history client module 112-1) to the gameplay history system 106. The system-side gameplay history management module 300 may manage updating gameplay history data stored on the system-side datastore 318 accordingly.

The system-side gameplay history editor module 302 may be configured to facilitate the review or editing of gameplay history data that is received from client devices (e.g., the client device 102-1) or gameplay history data that is maintained by the gameplay history system 106. For some embodiments, the system-side gameplay history editor module 302 obtains gameplay history data maintained on the system-side datastore 318, and presents a visual representation of the gameplay choices in the obtained gameplay history data, where the visual representations correspond to key events in a game title to which the gameplay choices relate. Through the system-side gameplay history editor module 302, a user may review a given gameplay choice in the obtained gameplay history data, and may allow the user to modify that gameplay choice.

The validation module 304 may be configured to facilitate validation of gameplay history data that is received from client devices (e.g., the client device 102-1) or gameplay history data that is maintained by the gameplay history system 106. For example, the validation module 304 may enable the gameplay history system 106 to ensure that in gameplay history data, complex gameplay choices, which may be associated with in-line or non-linear game plotline, are free from conflict. For some embodiments, every time gameplay history data is pushed to the gameplay history system 106, the gameplay history data is validated by the validation module 304.

For a given set of game titles, the validation module 304 may utilize game logic associated (e.g., governing) with the given set of game titles to determine if the gameplay history data contains two or more conflicting gameplay choices (e.g., gameplay history data indicates a gameplay choice that causes a character to be killed, and the validation module 304 detects when the death of character conflicts with another gameplay choice). The game logic may determine the possible set of gameplay choices available for one or more game titles (e.g., series of game titles for a game franchise, such as Dragon Age®).

In some embodiments, the validation module 304 traverses a logic tree associated with gameplay choices of a game title to determine whether gameplay choices are in conflict within gameplay history data. The validation module 304 may traverse the logic tree backwards and forwards (e.g., concurrently or serially) and find any gameplay choices during the traversal.

The resolution module 306 may be configured to facilitate resolution of one or more issues detected in gameplay history data, such as resolving conflicts between two or more gameplay choices included in the gameplay history data. The issues resolved by the resolution module 306 may be those detected by the validation module 304. The resolution module 306 may be implemented using an algorithm that uses game logic associated with a game title to ensure that a gameplay choice in gameplay history data is valid after the gameplay choice has been modified by a player (e.g., through the system-side gameplay history editor module 302).

In order to address conflicting gameplay choices detected in gameplay history data, the algorithm for the validation module 304 may comprise changing a gameplay choice modified in gameplay history data to comply with an existing gameplay choice in the gameplay history data (e.g., change a gameplay choice so that a character has not been killed to end a conflict). The algorithm for the validation module 304 may comprise changing an existing gameplay choice in the gameplay history data to comply with a gameplay choice modified in the gameplay history data. The algorithm for the validation module 304 may provide a player with a list of valid options for an existing gameplay choice in the gameplay history data, or a gameplay choice modified in the gameplay history data, when conflicting gameplay choices (e.g., existing or modified) are unable to be resolved automatically by the algorithm.

Where a logic tree is utilized for game logic validation, the resolution module 306 may attempt to resolve conflicting gameplay choices by adjusting one of the conflicting gameplay choices. In the event the resolution module 306 determines an adjustment to a particular gameplay choice to resolve conflicting gameplay choices, and the particular gameplay choice is locked, the resolution module 306 may attempt to adjust another gameplay choice, or may prompt a player for a response (e.g., invite them to resolve the issue, or quit).

The system-side export module 308 may be configured to facilitate exportation of gameplay history data from the gameplay history system 106 to a client device. For example, the system-side export module 308 may receive a request from a game title at a client device (e.g., the first game title 110-1 on the client device 102-1) for gameplay history data associated with a particular game title, and the system-side export module 308 may obtain a copy of gameplay history data associated with the particular game title. Eventually, the system-side export module 308 may provide (e.g., transmit) the obtained gameplay history data to the client device. The game title requesting the gameplay history data may be one intending to import the gameplay history data that is eventually provided by the system-side export module 308.

The filter module 310 may be configured to filter gameplay history data, requested by a client device, before the system-side export module 308 exports the gameplay history data and it is provided to the client device. The gameplay history data may be filtered according to one or more filters or filter rules associated with the game title requesting gameplay history data from the system-side export module 308. The filters or filter rules may identify a subset of data in the gameplay history data that will be included in the filtered gameplay history data to be exported by the system-side export module 308, and the subset of data identified by the filters or filter rules may be one that is relevant to or compatible with the game title requesting gameplay history data through the system-side export module 308.

The system-side import module 312 may be configured to facilitate the gameplay history system 106 receiving (e.g., importing) gameplay history data, or updates to gameplay history data, from a client device (e.g., the client device 102-1 operating the first game title 110-1). For example, with respect to a given game title, the system-side import module 312 may receive gameplay history data regarding a player's gameplay of the given game title, and may further receive updates to the gameplay history data as the player's gameplay of the given game title continues. When receiving gameplay history data from a client device, the system-side import module 312 may convert the gameplay history data to a particular format which may facilitate validation of, storage of, or resolution of issues in the gameplay history data. The system-side import module 312 may convert the gameplay history data to a format that is common to a given set of game titles, common to a given game type, or common to all gameplay history data received through the system-side import module 312.

The system-side GUI module 314 may be configured to facilitate generation or presentation of a graphical user interface that permits a player at a client device to access or interact with various features provided through a gameplay history client module. For example, the system-side GUI module 314 may facilitate the generation or presentation of a visual and interactive view that summarizes key events of a game plotline in view of gameplay history data being maintained by a gameplay history system. In another example, the system-side GUI module 314 may facilitate the generation of a GUI that allows for management of gameplay history data maintained by the gameplay history system 106 through the system-side gameplay history management module 300.

The system-side communication module 316 may be configured to facilitate communication of data between the gameplay history system 106 and a gameplay history client module (e.g., the gameplay history client module 112-1). In some embodiments, the system-side communication module 316 may directly communicate data with the gameplay history client module, may communicate data by way of an online video game network, or may communicate data by some combination of both. In doing so, the system-side communication module 316 may utilize one or more a network connections with the gameplay history client module or the online video game network to communicate the data.

The system-side datastore 318 may be configured to facilitate storage and future retrieval of the gameplay history data 320 received from a gameplay client module (e.g., the gameplay history client module 112-1) for storage, editing, or importation purposes. The system-side datastore 318 may include the game logic data 322, which describes game logic that may be used by the validation module 304 to validate gameplay history data or the resolution module 306 to resolve one or more conflicting gameplay choices in the gameplay history data. The system-side datastore 318 may include the filter data 324, which may describe filters or filter rules that are used by the filter module 310 to filter gameplay history data, according to one or more game titles, before the gameplay history data is provided (e.g., exported) to a client device. The system-side datastore 318 may further include data regarding settings, game player preferences, or other information that can affect the behavior or operation of the gameplay history system 106.

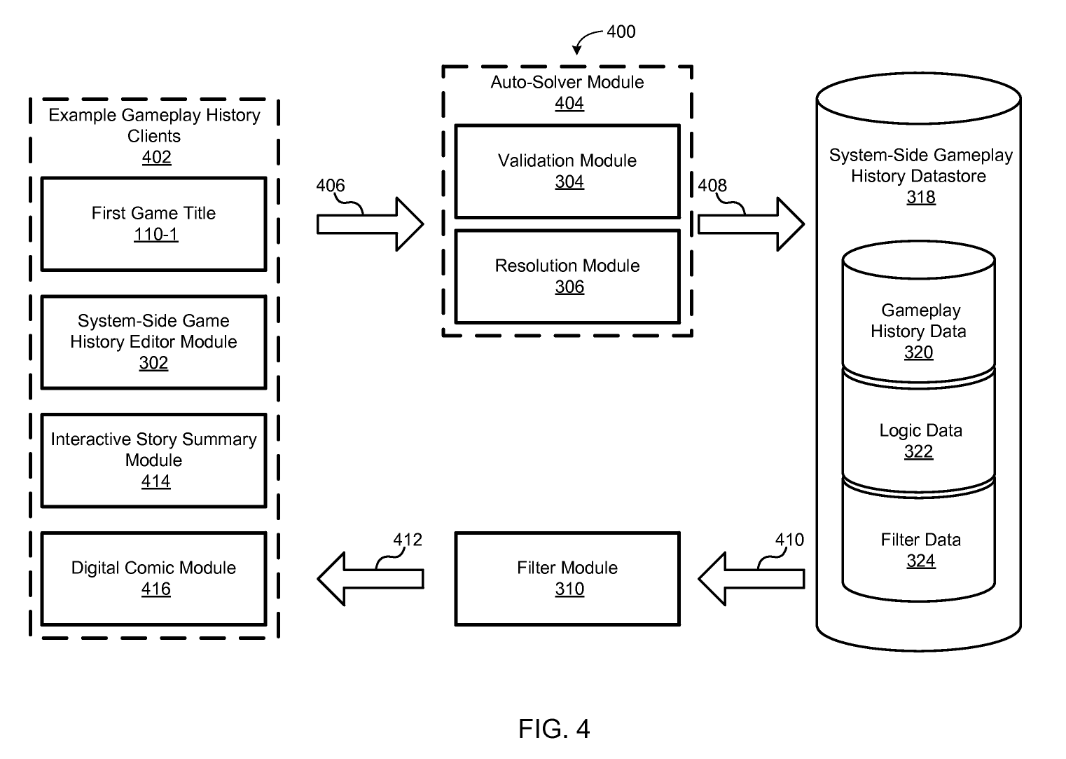

FIG. 4 is a diagram illustrating an example data flow 400 of the gameplay history system 106 in accordance with some embodiments of the invention. As shown in FIG. 4, the example data flow 400 involves example gameplay history clients 402, an auto-solver module 404, the system-side datastore 318 of the gameplay history system 106, and the filter module 310 of the gameplay history system 106.

Examples gameplay history clients 402 that may operate with the gameplay history system 106 include the first game title 110-1 of client device 102-1, the system-side gameplay history editor module 302 of the gameplay history system 106, an interactive story summary module 414, or a digital comic module 416. As described herein, the first game title 110-1 may provide gameplay history data to the gameplay history system 106, and may have imported gameplay history data from the gameplay history system 106. As also described herein, the system-side gameplay history editor module 302 of the gameplay history system 106 may facilitate a player reviewing and editing gameplay history data maintained by the gameplay history system 106. The interactive story summary module 414 may be configured to receive gameplay history data from the gameplay history system 106 and render a visual representation of gameplay choices in the gameplay history data. The visual representation may present key events in the game plotline of a game title, where the game plotline is influenced by (e.g., unfolds) based on the gameplay choices in gameplay history data associated with the game title. In one example, the interactive story summary module 414 may present a mosaic of slides, a carrousel of slides, or the like representing one or more key events from a game title, and each slide presents an image from the game title that represents a key event. The digital comic module 416 may be configured to receive gameplay history data from the gameplay history system 106 and render an interactive or non-interactive digital comic having a plotline based on gameplay information provided by the received gameplay history data.

Depending on the embodiment, the first game title 110-1 may collect gameplay information as a player participates in gameplay provided by the first game title 110-1. At data flow 406, the first game title 110-1 may provide the collected gameplay information to the gameplay history system 106 as gameplay history data.

The gameplay history system 106 may include the auto-solver module 404, which may validate gameplay choices in the gameplay history data provided by the first game title 110-1 and resolve any detected issues (e.g., gameplay choice conflicts) that exist in the provided gameplay history data. Once the gameplay history data has been validated and resolved when necessary, the auto-solver module 404 may permit the validated/resolved gameplay history data to be stored (data flow 408) to the system-side datastore 318, which may include it as part of the gameplay history data 320. The auto-solver module 404 may include the validation module 304 and utilize the validation module 304 to validate the gameplay history data provided by the first game title 110-1. The auto-solver module 404 may include the resolution module 306 and utilize the resolution module 306 to resolve one or more issues detected (e.g., gameplay choices) in the gameplay history data provided by the first game title 110-1.

When a gameplay history client, such as the first game title 110-1, the system-side gameplay history editor module 302, the interactive story summary module 414, or the digital comic module 416, requests gameplay history data from the gameplay history system 106, the gameplay history data 320, game logic data 322 and filter data 322 may be provided (data flow 410) to the filter module 310. The filter module 310 may apply a file or filter rule to the provided gameplay history data before the gameplay history data is provided to the requesting gameplay history client (data flow 412). As described herein, the filter or filter rule used by the filter module 310 may be one associated with one or more game titles for which the gameplay history client is requested gameplay history data. For example, an example client (e.g., 110-1) calls up requesting import data (e.g., Dragon Age 3 connects and requests import data for Dragon Age 3). Per game client logic data 322 and filter data 324 contain the rules/instructions for creating what Dragon Age 3 cares about (e.g., only about ⅔rd of all history data from Dragon Age 1 and Dragon Age 2). The logic data 322 and filter data 324 specific for Dragon Age 3 is delivered to the filter module 310, which creates a Dragon Age 3 specific subset of the gameplay history data 320, that is, the ⅔rd subset of data Dragon Age 3 cares about and in the format it can receive it in. The filter module 310 forwards the filtered data to the example client (e.g., 110-1). This allows new game clients to be added or existing clients to be fixed or updated, each with their own complex data needs over time without impacting previously setup titles or the rest of the system.

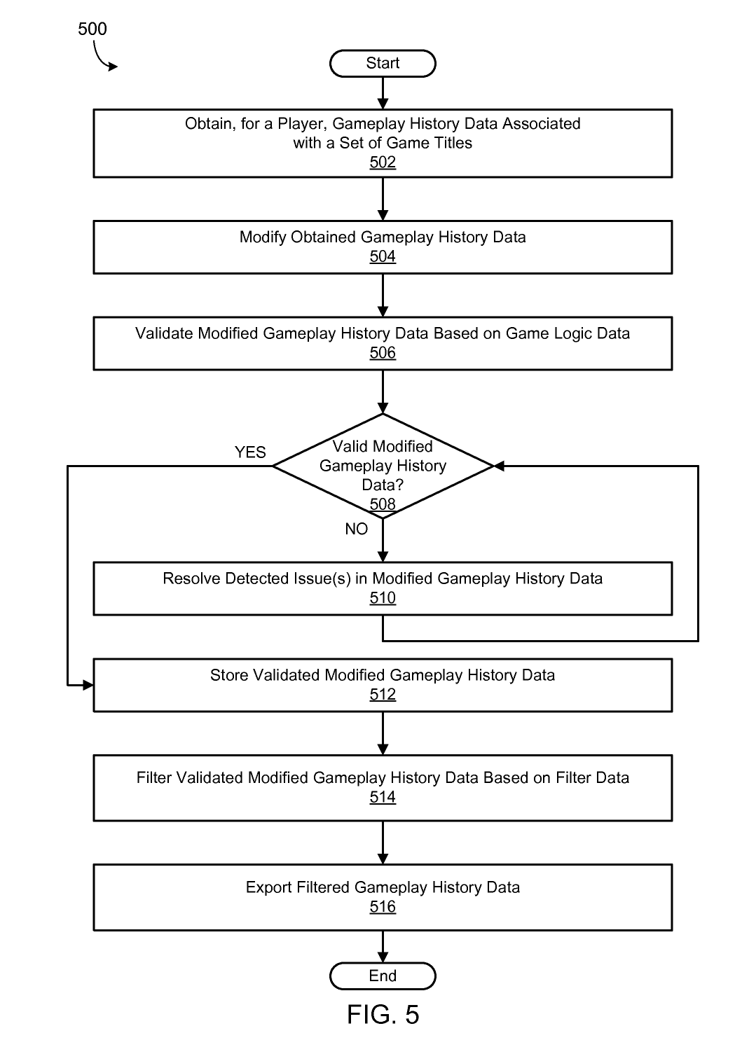

FIG. 5 is a flowchart illustrating an example method 500 for gameplay history in accordance with some embodiments of the invention. As described below, for some embodiments, the method 500 may perform operations in connection the gameplay history system 106. The method 500 may begin at step 502, with the system-side gameplay history management module 300 obtaining, for a player, gameplay history data associated with a set of game titles. The gameplay history data may be obtained from the system-side datastore 318, where the gameplay history system 106 can maintain the gameplay history data. As described herein, the gameplay history data maintained on the system-side datastore 318 may include gameplay history data received from a game title operating on a client device, or gameplay history data generated/modified at the gameplay history system 106 at the request of a player.

At step 504, the system-side gameplay history editor module 302 may modify the gameplay history data obtained at step 502. For instance, the system-side gameplay history editor module 302 may modify the gameplay history data by modifying one or more gameplay choices in the gameplay history data, where those one or more modified gameplay choices may correspond with, cause, or represent a key event in a game plotline. Depending on the embodiment, through the system-side gameplay history editor module 302, a player may be visually presented with one or more gameplay choices in the obtained gameplay history data (e.g., presented to the player through a visual or interactive view), may review those gameplay choices, and then may choose to alter one or more of those gameplay choices. One or more alterations to a gameplay choice in the obtained gameplay history data may result in one or more alterations to the visual presentation of the gameplay choices. As described herein, one or more alterations to the gameplay choice may result in a cascade of other alterations to gameplay choices in the obtained gameplay history data, which in turn may result in one or more alterations to the visual presentation of the gameplay choices.

At step 506, the validation module 304 may validate the modified gameplay history data produced at step 504, and may validate the modified gameplay history data based on game logic data associated with a set of game titles to which the gameplay history data is associated. The validation module 304 may validate the modified gameplay history data, based on the game logic data, by detecting for one or more issues in the modified gameplay history data, where the detecting is based on the game logic data. As described herein, the one or more issues detected in the modified gameplay history data may result from modifications applied to the gameplay history data at step 504. As shown in FIG. 5, if the modified gameplay history data is determined to be valid by the validation module 304 at step 506, at step 508 the method 500 continues to step 512. If the modified gameplay history data is determined to be invalid by the validation module 304 at step 506, at step 508 the method 500 continues to step 510.

At step 510, the resolution module 306 may resolve a set of issues detected in the modified gameplay history data at step 506. Depending on the embodiment, the resolution module 306 may resolve the set of issues (in the modified gameplay history data) by determining a minimal set of modifications that when applied to the modified gameplay history data, resolves at least some of the set of issues, and then then applying the minimal set of modifications to the modified gameplay history data. For some embodiments, the method 500 may perform steps 506, 508, and 510 in multiple loops, whereby the validation module 304 may validate resolved gameplay history data produced at step 510, and if the resolved gameplay history data is determined to be invalid at step 508, the resolution module 306 may resolve a set of issues detected in the resolved gameplay history data at step 506. The method 500 may continue looping through steps 506, 508, and 510 until a valid gameplay history data is detected at step 508. Programmatically, the system may pre-calculate valid paths using a greedy algorithm and take the path of least resistance (least number of changes).

At step 512, gameplay history data determined to be valid at step 508 may be stored at the system-side datastore 318. By validating gameplay history data before it is stored on the system-side datastore 318, the method 500 can ensure that gameplay history data stored on the system-side datastore 318 and ready for importation can be imported into a target game title with little or no risk of the imported gameplay history data disrupting or breaking the game logic of the target game title. Additionally, by validating gameplay history data before it is stored on the system-side datastore 318, various embodiments can obviate the need for each importing game title to implement validation or resolution processes for the gameplay history data.

At step 514, the filter module 310 may filter the validated modified gameplay history data based on filter data, where the validated modified gameplay history data may be obtained from the system-side datastore 318. The method 500 may perform step 514 after a request for gameplay history data is received from a target game title (e.g., the first game title 110-1 operating on a client device 102) wishing to import gameplay history data. For some embodiments, the filter data utilized by the filter module 310 is associated with the target game title. As described herein, the filter data may comprise a filter or filter rule that identify a subset of data in the gameplay history data that will be included in the filtered gameplay history data to be produced, and the subset of data identified by the filter or filter rule may be one that is relevant to or compatible with the target game title intending to import the filtered gameplay history data.

At step 516, the system-side export module 308 may export the filtered gameplay history data to the client device 102, where a target game title operating on the client device 102 (e.g., the first game title 110-1) or some other software can receive and utilize (e.g., import) the filtered gameplay history data.

Though the operations of method 500 may be depicted and described above in a certain order, those skilled in the art will appreciate that the order in which the operations are performed may vary between embodiments, including performing certain operations in parallel. Additionally, those skilled in the art will appreciate that the components described above with respect to the method 500 of the flowchart are merely examples of components that may be used with the method, and for some embodiments other components may also be utilized in some embodiments.

FIG. 6 is a block diagram of a computer system 600. The computer system 600 comprises a processor 602, a memory system 604, a storage system 606, a communication network interface 608, an I/O interface 610, and a display interface 612 communicatively coupled to a communication channel 614. The processor 602 is configured to execute executable instructions (e.g., code). In some embodiments, the processor 602 comprises circuitry and/or any processor capable of processing the executable instructions.

The memory system 604 is any memory configured to store data. Some examples of the memory system 604 include storage devices, such as RAM, ROM, RAM cache, etc. In various embodiments, data is stored within the memory system 604. The data within the memory system 604 may be cleared or ultimately transferred to the storage system 606.

The storage system 606 is any storage configured to retrieve and store data. Some examples of the storage system 606 are flash drives, hard drives, optical drives, and/or magnetic tape. In some embodiments, the computer system 600 includes a memory system 604 in the form of RAM and a storage system 606 in the form of flash. Both the memory system 604 and the storage system 606 comprise computer readable media that stores instructions that are executable by the processor 602.

The communication network interface (com. network interface) 608 can be coupled to a network (e.g., computer network 116) via the communication channel 616. The communication network interface 608 may support communication over an Ethernet connection, a serial connection, a parallel connection, or an ATA connection, for example. The communication network interface 608 may also support wireless communication (e.g., 802.11 a/b/g/n, WiMax). It will be apparent to those skilled in the art that the communication network interface 608 can support many wired and wireless standards.

The input/output (I/O) interface 610 is any device that receives input from the user and outputs data to the user. The display interface 612 is any device that is configured to output graphics and data to a display. In one example, the display interface 612 is a graphics adapter. It will be appreciated that not all computer systems 600 comprise either the I/O interface 610 or the display interface 612.

It will be appreciated by those skilled in the art that the hardware elements of the computer system 600 are not limited to those depicted. A computer system 600 may comprise more or less hardware elements than depicted. Further, hardware elements may share functionality and still be within various embodiments described herein. In one example, encoding and/or decoding may be performed by the processor 602 and/or a co-processor located on a GPU (e.g., NVidia). The above-described functions and components may comprise instructions stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

It will be appreciated that a “module” as referred to herein may comprise software, hardware, firmware, and/or circuitry. In one example, one or more software programs comprising instructions capable of being executable by a processor may perform one or more of the functions of the engines described herein. In another example, circuitry may perform the same or similar functions. Alternative embodiments may comprise more, less, or functionally equivalent engines and still be within the scope of present embodiments.

It will also be understood that the term “set” as used herein may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

1. A method comprising:
modifying gameplay history data associated with a first game title to produce first modified gameplay history data, the gameplay history data being associated with a player and being associated with a set of game titles including the first game title;
validating the first modified gameplay history data based on game logic data associated with the set of game titles, the validating comprising determining whether the first modified gameplay history data raises one or more issues that cause the first modified gameplay history data to be invalid;
resolving a first set of issues raised by the first modified gameplay history data to produce modified and resolved gameplay history data;
filtering the modified and resolved gameplay history data, based on filter data, to produce filtered gameplay history data, the filter data being associated with a second game title; and
providing the filtered gameplay history data to the second game title.

2. The method of claim 1, further comprising maintaining the gameplay history data at an online data repository, wherein at least some of the gameplay history data is generated by the player playing or replaying the first game title, or the at least some of the gameplay history data is generated at the online data repository based on a request from the player without the player playing or replaying the first game title.

3. The method of claim 1, wherein the gameplay history data comprises a set of gameplay flags that determine at least a portion of a state of a game world associated with the first game title, and the state of the game world determines at least a portion of a gameplay environment provided by the first game title or a game plotline followed by the first game title.

4. The method of claim 1, wherein the gameplay history data is an existing copy of gameplay history data associated with the player, or a new copy of gameplay history data generated based on default gameplay history data.

5. The method of claim 1, wherein the modifying the gameplay history data associated with the player comprises modifying a gameplay flag included in the gameplay history data.

6. The method of claim 5, wherein the gameplay flag represents a gameplay choice available for selection by the player during gameplay of the first game title, or a player accomplishment earned during gameplay of the first game title.

7. The method of claim 1, wherein the resolving the first set of issues comprises:
determining a minimal set of modifications to the first modified gameplay history data that resolve at least some of the first set of issues; and
applying the minimal set of modifications to the first modified gameplay history data.

8. The method of claim 7, wherein the applying the minimal set of modifications to the first modified gameplay history data produces second modified gameplay history data, the method further comprising validating the second modified gameplay history data based on logic data that is associated with the first game title, the validating comprising determining whether the second modified gameplay history data raises one or more issues that cause the second modified gameplay history data to be invalid.

9. The method of claim 8, further comprising resolving a second set of issues raised by the second modified gameplay history data to produce interim gameplay history data, the interim gameplay history data replacing the first modified gameplay history data.

10. The method of claim 1, further comprising repeating a cycle of the validating the first modified gameplay history data and the resolving the first set of issues raised by the first modified gameplay history data, until the first modified gameplay history data is determined to be valid.

11. The method of claim 7, wherein the minimal set of modifications includes at least one modification relating to a gameplay choice locked by the player.

12. A system comprising:
means for modifying gameplay history data associated with a first game title to produce modified gameplay history data, the gameplay history data being associated with a player and being associated with a set of game titles including the first game title;
means for validating the modified gameplay history data based on game logic data associated with the set of game titles, the validating comprising determining whether the modified gameplay history data raises one or more issues that cause the modified gameplay history data to be invalid;
means for resolving a set of issues raised by the modified gameplay history data to produce modified and resolved gameplay history data;
means for filtering the modified and resolved gameplay history data, based on filter data, to produce filtered gameplay history data, the filter data being associated with a second game title; and
means for providing the filtered gameplay history data to the second game title.

13. A system comprising:
a gameplay history editor module configured to modify gameplay history data associated with a first game title to produce first modified gameplay history data, the gameplay history data being associated with a player and being associated with a set of game titles including the first game title;
a validation module configured to validate the first modified gameplay history data based on game logic data associated with the set of game titles, the validating comprising determining whether the first modified gameplay history data raises one or more issues that cause the first modified gameplay history data to be invalid;
a resolution module configured to resolve a first set of issues raised by the first modified gameplay history data to produce modified and resolved gameplay history data;
a filter module configured to filter the modified and resolved gameplay history data, based on filter data, to produce filtered gameplay history data, the filter data being associated with a second game title; and
an export module configured to export the filtered gameplay history data to the second game title.

14. The system of claim 13, further comprising a gameplay history datastore configured to maintain the gameplay history data at an online data repository, wherein at least some of the gameplay history data is generated by the player playing or replaying the first game title, or the at least some of the gameplay history data is generated at the online data repository based on a request from the player without the player playing or replaying the first game title.

15. The system of claim 13, wherein the gameplay history data comprises a set of gameplay flags that determine at least a portion of a state of a game world associated with the first game title, and the state of the game world determines at least a portion of a gameplay environment provided by the first game title or a game plotline followed by the first game title.

16. The system of claim 13, wherein the gameplay history data is an existing copy of gameplay history data associated with the player, or a new copy of gameplay history data generated based on default gameplay history data.

17. The system of claim 13, wherein the modifying the gameplay history data associated with the player comprises modifying a gameplay flag included in the gameplay history data.

18. The system of claim 17, wherein the gameplay flag represents a gameplay choice available for selection by the player during gameplay of the first game title, or a player accomplishment earned during gameplay of the first game title.

19. The system of claim 13, wherein the resolving the first set of issues comprises:
determining a minimal set of modifications to the first modified gameplay history data that resolve at least some of the first set of issues; and
applying the minimal set of modifications to the first modified gameplay history data.

20. The system of claim 19, wherein the applying the minimal set of modifications to the first modified gameplay history data produces second modified gameplay history data, the validation module being further configured to validate the second modified gameplay history data based on logic data that is associated with the first game title, the validating comprising determining whether the second modified gameplay history data raises one or more issues that cause the second modified gameplay history data to be invalid.

21. The system of claim 20, wherein the resolution module is further configured to resolve a second set of issues raised by the second modified gameplay history data to produce interim gameplay history data, the interim gameplay history data replacing the first modified gameplay history data.

22. The system of claim 21, wherein the validation module and the resolution module are configured to repeat a cycle of the validating the first modified gameplay history data and the resolving the first set of issues raised by the first modified gameplay history data, until the first modified gameplay history data is determined to be valid by the validation module.

23. The system of claim 19, wherein the minimal set of modifications includes at least one modification relating to a gameplay choice locked by the player.

24. A method comprising:
receiving gameplay history data for a first game title, the gameplay history data being generated by a player playing or replaying the first game title;
modifying the gameplay history data to produce modified gameplay history data;
validating the modified gameplay history data based on game logic data associated with the first game title, the validating the modified gameplay history data comprising determining whether the modified gameplay history data raises one or more issues that cause the modified gameplay history data to be invalid;
resolving a set of issues raised by the modified gameplay history data to produce modified and resolved gameplay history data; and
providing the modified and resolved gameplay history data to a second game title.

25. The method of claim 24, further comprising:
validating the modified and resolved gameplay history data based on the game logic data associated with the first game title, the validating the modified and resolved gameplay history data comprising determining whether the modified and resolved gameplay history data raises one or more issues that cause the modified and resolved gameplay history data to be invalid; and
resolving a second set of issues raised by the modified and resolved gameplay history data to produce interim gameplay history data, the interim gameplay history data replacing the modified gameplay history data.
